(19) United States
(12) Patent Application Publication
(10) Pub. No.: US 2024/0423191 A1
(43) Pub. Date: Dec. 26, 2024

(54) DEVICE AND METHOD FOR MECHANICAL MAINTENANCE OF A LAWN TO LIMIT THE GROWTH OF WEEDS

(71) Applicant: IC Green, Crolles (FR)

(72) Inventor: Christophe Blondiaux, Montbonnot Saint Martin (FR)

(21) Appl. No.: 18/701,314

(22) PCT Filed: Oct. 12, 2022
(86) PCT No.: PCT/FR2022/051922

§ 371 Date: Apr. 15, 2024

(30) Foreign Application Priority Data
Oct. 15, 2021 (FR) FR2110948

(51) Int. Cl. A01M 21/02

(52) U.S. Cl. CPC A01M 21/02

(57) ABSTRACT

A device for mechanical maintenance of a lawn with a view to limiting the growth of weeds, has at least one tool including a plate defining a main plane and carrying a plurality of rods. The rods extend in a direction perpendicular to the main plane. The free ends of the rods are intended to rest on the lawn. The tool includes a drive mechanism associated with the plate that is configured to rotate the assembly formed by the plate and the rods about an axis of rotation perpendicular to the main plane.

### CROSS REFERENCE TO RELATED APPLICATIONS

This application is a national phase entry under 35 U.S.C. § 371 of International Patent Application PCT/FR2022/051922, filed Oct. 12, 2022, designating the United States of America and published as International Patent Publication WO 2023/062317 A1 on Apr. 20, 2023, which claims the benefit under Article 8 of the Patent Cooperation Treaty to French Patent Application Serial No. FR2110948, filed Oct. 15, 2021.

### TECHNICAL FIELD

The field of the invention is that of maintaining a lawn in order to limit the growth of weeds.

### BACKGROUND

Whether the lawn is intended for farming (fields, meadows, etc.) or leisure (garden, parks, sports terrain, golf courses, etc.), it is customary to spread selective weed killers to limit or even eliminate the growth of weeds.

It will be recalled that the term “weeds” denotes plant species growing in the soil, without having been intentionally seeded therein. They are therefore plant species foreign to the cultivated varietal or to the herbaceous plants in a soil.

It is generally sought to limit the use of chemical weed killers, as a choice in the context of organic farming, for the sake of saving money, or as an obligation (to comply with standards or laws).

In order to nonetheless maintain soil and to limit the growth of weeds, it has been contemplated to prune a protruding part thereof, when their height is greater than that of the plants or grass growing in the lawn.

Documents FR2973645 and FR2463571 present devices making it possible to implement such a pruning solution.

In these two documents, a cable or a blade is rotated above the crops in order to cut this protruding part of the weeds. In these solutions, the cutting element (cable or blade) therefore extends in a substantially horizontal plane to intercept the stems of the plants, whose heads are to be cut off, at a right angle.

This solution is not entirely satisfactory, since these pruners have a limited ability to maintain the lawn. They can treat only those weeds that have a protruding part.

Documents WO2008/135867 and FR2520187 propose two devices for treating a soil covered with plants cultivated in rows. Devices are disclosed having teeth that are intended to penetrate into the soil, in order to weed or prune plants. These devices are designed and operated to treat only part of the lawn, in order to preserve the seedlings. They are not able to fully treat a lawn with a view to selectively limiting the growth of weeds.

### BRIEF SUMMARY

One aim of the present disclosure is to at least partially solve this problem. More specifically, one goal of the present disclosure is to propose a device distinguished from this prior art to allow mechanical maintenance of a lawn in order to selectively limit the growth of weeds.

In order to achieve this goal, the subject matter of the present disclosure proposes a device for mechanically maintaining a lawn in order to limit the growth of weeds, the device comprising at least one tool comprising:
a plate defining a main plane and carrying a plurality of rods, the rods having sections with rounded shapes, the rods extending in a direction perpendicular to the main plane, the free ends of the rods being intended to be flush with the lawn, and
a drive mechanism associated with the plate and intended to rotate the assembly formed by the plate and the rods along an axis of rotation perpendicular to the main plane.

Particularly surprisingly, this tool allows for a mechanical and selective treatment of the plant species composing a lawn. The desired plant species, grasses consisting of a simple flexible stem, are moved aside upon passage of the rods of the tool and are instead preserved by this tool, in particular, by virtue of the rounded shape of the rods. On the contrary, the undesired plant species, whose foliage is relatively extended, cannot completely move aside and are partially destroyed or weakened by the passage of the rods of the tool.

According to one embodiment, the plate is disc-shaped, and the axis of rotation intersects the plate at the center of the disc.

According to one embodiment, the drive mechanism comprises a motor and a shaft defining the axis of rotation, the shaft of the motor being rigidly connected to the plate.

According to one embodiment, the rods are curry-comb claws.

According to one embodiment, the rods are retained on the plate along at least one circle whose center is in line with the axis of rotation of the tool.

According to one embodiment, the device comprises a chassis, a plurality of wheels, the tool being held on the chassis by at least one articulated mechanism, the articulated mechanism enabling the free movement of the tool in a direction perpendicular to the lawn in order to absorb the variations in elevation of the lawn when the device is in motion and the tool is resting on the lawn.

According to one embodiment, the articulated mechanism is connected to a load-bearing structure of the chassis, the tool being suspended from the load-bearing structure by a retaining member to control the force exerted by the ground on the rods of the tool.

According to one embodiment, the retention member is configured to allow the adjustment of the pressure exerted by the ground on the rods.

According to one embodiment, the articulated mechanism is associated with a mechanism for lifting the tool, the lifting mechanism making it possible to selectively place the tool in a working position wherein the free ends of the rods are flush with the lawn and to place the tool in a raised position wherein the free ends of the rods are far away from the lawn.

According to one embodiment, the device comprises an electric drive system coupled to at least some of the wheels.

According to one embodiment, the device comprises a control unit connected to a geolocation sensor and to the electric drive system in order to make the device autonomous.

According to one embodiment, the control unit is also connected to the mechanism for lifting the tool to selectively place the tool in the working position or in the raised position.

According to one embodiment, the control unit is also connected to a system for observing the lawn and for detecting weeds.

According to another aspect, the present disclosure proposes the use of a device as presented above for treating a lawn with a view to limiting the growth of weeds.

According to yet another aspect, the present disclosure proposes a method for treating a lawn in order to limit the growth of weeds, the method comprising the following steps:
configuring a device as described above to position the tool in a working position wherein the free ends of the rods are flush with the ground; and
activating the drive mechanism and rotating the plate and the rods.

### BRIEF DESCRIPTION OF THE DRAWINGS

Other features and advantages of the invention will become apparent from the following detailed description of example embodiments of the present disclosure with reference to the appended figures, wherein:

FIG. 1 shows a tool equipping a device for mechanical maintenance of a lawn according to the present disclosure;

FIG. 2 shows a curry-comb claw with which a tool according to the present disclosure may be provided;

FIG. 3 shows a schematic top view of a device for mechanical maintenance of a lawn according to the present disclosure;

FIGS. 4A and 4B, respectively, show a device in the working position and in the raised position; and

FIG. 5 shows a functional diagram of the circuits that can equip the device according to one embodiment.

### DETAILED DESCRIPTION

### Tool

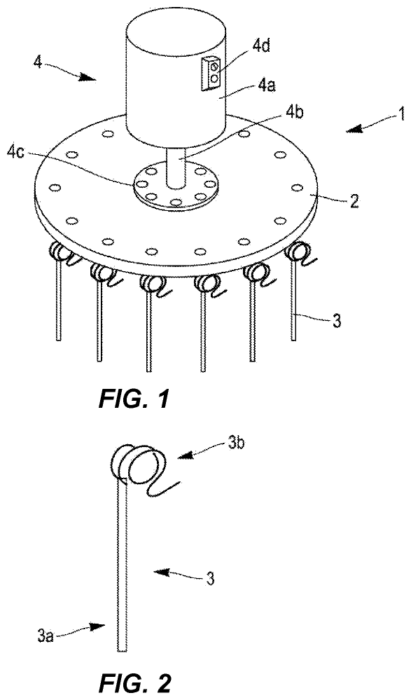

FIG. 1 shows a tool 1 equipping a device for mechanical maintenance of a lawn according to the present disclosure.

This tool 1 is formed by a plate 2, here disc-shaped, defining a main plane of the tool 1. The plate 2 carries a plurality of rods 3 that extend in a direction perpendicular to the main plane. These rods are rigidly connected to the plate at one of their ends, the other end therefore forming a free and projecting end of the tool 1. The term “rod” refers to an element having a wire-shaped, thin, elongate form factor, but it is not necessary for this element to be perfectly slender.

The free ends of the rods 3 are intended to come closer to the ground, or even to rest on the ground with limited pressure, when the tool is in operation. These free ends are therefore arranged in a single plane, which can be obtained by using rods 3 that all have substantially the same length, to within 1 mm or 2 mm. Advantageously, the rods 3 are metallic.

Provision may be made to provide the plate 2 of the tool 1 with any number of rods, but typically this number is between 10 and 50. The density of these rods 3 on the plate define the intensity of the mechanical treatment of the lawn. These rods 3 are distributed on the surface of the plate 2, here along a peripheral circle of the disc-shaped plate 2. Any other distribution of the rods 3 could naturally be provided on the plate 2, for example, along a plurality of concentric circles. Generally, it will be preferred to group at least part of the rods 3 on a peripheral zone of the plate 2, so that the latter can have a high (and relatively identical) tangential speed when, during the operation of the tool, the plate is rotated as will be explained in greater detail further on in this description.

In the preferred embodiment shown in FIG. 1, the rods 3 are made up of curry-comb claws, that is rods 3a that are straight and flexible and/or retained on the plate by means of a spring 3b. Such a claw is shown in FIG. 2. These rods are capable of deforming and/or of pivoting on the plate at the spring 3b, when they are subjected to a force, for example, when they encounter an obstacle or when the tool 1 is too close to the ground.

By way of illustration only, the plate 2, when it is disc-shaped, may have a diameter on the order of 30 cm, and the rods 3 have a length typically between 10 and 30 cm.

The rods 3 have a section, in a plane parallel to the plate, that is of rounded shape, that is to say free of any protruding angle. This avoids having to form a rod having a cutting edge that could damage or cut the grass that it is desired to treat, when the tool is rotated. The rod has this rounded shape at least in the portion of the rod that is intended to be engaged in the thickness of grass, on the side of its free end. A rod 3 may have a cross-section of free shape on the side intended to be associated with the plate. The rounded shape may have a circular or oblong contour, for example, or polygonal. When this contour has an angle, as is the case with a polygonal contour, the latter does not protrude, that is to say it has a magnitude greater than 95°, advantageously greater than 120°, or even 160°. Typically, the contour is inscribed in a circle having a diameter on the order of a millimeter, and typically between 1 mm and 5 mm. This diameter corresponds somewhat to the thickness of the rod 3. The rods 3 of a tool 1 do not necessarily all have a cross-section having the same shape or the same thickness.

The tool 1 further comprises a drive mechanism 4 associated with the plate and intended to rotate the assembly formed by the plate 2 and the rods 3 along an axis of rotation perpendicular to the main plane.

This drive mechanism 4 in the embodiment shown consists of an electric motor 4a rotating a shaft 4b rigidly connected to the plate 2 by way of a fastening plate 4c. Here, the electric motor is provided with a connector 4d enabling it to be supplied with electricity and to control it via a cable harness. The shaft 4b defines the axis of rotation of the plate 2 and of the rods 3; it is fastened to the plate 2 via the fastening plate 4c so that the axis of rotation intersects the plate at its center. The electric motor 4a can also be provided with means making it possible to securely fasten it to a tool holder, such as a chassis, as will be explained in the rest of this description.

It would naturally be possible to provide for other ways of producing the drive mechanism 4 than by means of the electric motor 4a taken as an example and shown in FIG. 1. It would thus be possible to offset this motor and to drive the plate 2 and the rods 3 by a pulley/belt mechanism. This is, in particular, the case when a maintenance device is equipped with a plurality of tools, and it is sought to share the motor to rotate the plurality of these tools simultaneously.

In all cases, and regardless of how the drive mechanism 4 is implemented, the latter is able to rotate the plate 2 and the claws 3 at a rotational speed of several hundred revolutions/min or even several thousand revolutions/min. Advantageously, this rotational speed is chosen to obtain a tangential speed of movement of the rod (or rods) arranged furthest from the center of rotation that is greater than 30 km/h, preferably greater than 40 km/h and more preferably still greater than 50 km/h. Thus, when the rods are arranged in a peripheral zone of a plate 15 cm in diameter, the rotational speed may be chosen to be on the order of 2000 rpm. In general, a greater rotational speed leads to a better treatment quality, up to a limit speed beyond which the grass may be damaged. Advantageously, the rotational speed is variable and controllable, so as to be able to adjust the intensity of the soil treatment.

A large rotational speed can lead to the deformation of the rods 3, by centrifugal effect when the rods are relatively flexible, so that they are no longer arranged perpendicularly to the ground during the treatment. Also, to at least partially offset this effect that may affect the quality of the treatment, it is possible to position the rods 3 on the plate 2 by orienting them towards the inside of the tool 1, when this tool is not being rotated. This can be obtained by the shape of the rods 3 itself or by giving a slightly concave shape to the plate 2.

In all cases, it is ensured that the free ends of the rods 3 lie substantially in the same plane, so that they can all come close to the ground and be flush with it.

In operation, the tool is arranged so that the free end of each of the rods 3 is flush with a lawn. This lawn consists of grasses or other forms of herbaceous plants that it is desired to preserve and that consist of flexible stems. The free ends of the rods 3 are therefore arranged in the thickness of the grass so that, typically, their free ends are distant by a few millimeters from the ground, up to 5 mm from the ground. Such free ends can also rest on the ground by exerting a greatly reduced pressure. Advantageously therefore, the distance separating the plate from the ground is controlled so that the pressure exerted by the ground on the rods 3 does not exceed a few tenths of a Newton, less than 0.5 N. In all cases, it is sought to avoid causing the rods 3 to penetrate into the ground, which could cause damage to the roots of the grasses or herbaceous plants that are to be treated.

To this end, it is advantageous to choose rods 3 and/or to retain them on the plate by way of a pivoting mechanism, as is the case of the curry-comb claws mentioned in a preceding passage, in order to prevent the rods from penetrating into the soil, in particular, when the ground is not perfectly flat and has protuberances.

The lawn may also comprise weeds, which it is desired to remove, which generally have leaves or a shape that extends further than those of the herbaceous plants that decorate the lawn.

In the operating position, the plate is arranged parallel to the ground, horizontally when the ground does not have a gradient. The drive mechanism is in operation and the plate 2 and the rods 3 are rotated at a speed that can reach several hundred revolutions/min, as mentioned above, so that at least some of the rods move with a high tangential speed, greater than 30 km/h.

The grasses and other herbaceous plants are not entirely affected by the rotational movement of the rods 3 resting on the ground, or arranged near the ground: these herbaceous herbs and plants tend to deform and move aside when the rotated rods 3 pass by. The rounded, and therefore non-sharp, cross-section of the rods 3 also avoids damaging the grass. On the contrary, foliage from the weeds cannot completely prevent the rods 3 from passing by. This foliage (one dimension of which in a horizontal plane is typically greater than 2 mm) is sheared by the rods 3 and destroyed, which tends to weaken these plants and limit their growth. In a particularly surprising manner, the tool therefore allows a mechanical and selective treatment of the plant species composing the lawn, in order to largely preserve the desired plant species while destroying or weakening the undesired plant species that have relatively extensive foliage.

The tool 1 has other beneficial effects for the soil, the rods 3, when they approach close enough, tend to scratch the soil, which tends to disperse, by scarification, the residues of grass clippings, mosses, root tangles, and other deposits that tend to accumulate between the plants and that block the necessary air and water exchanges of the soil.

### Mechanical Maintenance Device for a Lawn

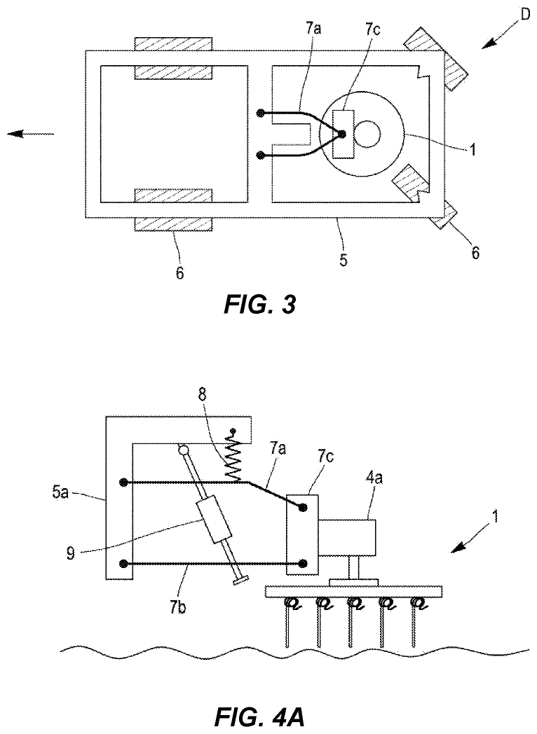

The tool, when associated with a tool holder, can be operated manually. But advantageously, it equips a rolling device for mechanically maintaining a lawn. With reference to FIG. 3, this device D comprises a chassis 5 on which the tool 1 and a plurality of wheels 6 are retained, making it possible to move this tool. This device D can then be towed, and in this case the chassis can be provided with a conventional coupling hook, or be motorized to form an independent maintenance vehicle. Advantageously, the device D comprises an electric drive system coupled to at least some of the wheels, for example, the two front wheels of the device. The other two wheels may consist of simple pivoting wheels. Regardless of the retained solution, towed or motorized, it is possible to treat a large field by going through it as would be done when mowing.

The speed of advance of the chassis, to allow the tool 1 to operate correctly, is preferentially between 2 and 10 km/h. To improve the quality of the mechanical treatment of the lawn, the rotational speed of the plate 2 and of the rods 3 can be adjusted by controlling the electric motor 4a of the tool according to the speed of advance of the device. The slower this speed of advance, the lower the rotational speed of the plate will be. A smaller number of rods 3 (or a lower density of rods 3) may also allow mechanical treatment of the lawn at low speed.

In both cases, it is advantageous to hold the tool onto the chassis by an articulated mechanism allowing the free movement of the tool 1 in a direction perpendicular to the lawn, for example, a deformable parallelogram. It is then possible to absorb the variations in the elevation of the ground when the device is in motion, when the tool is in a position wherein the ends of the rods 3 are flush with the ground.

Advantageously, the tool 1 is suspended from a load-bearing structure of the chassis, via a retaining member, such as a spring, in a position wherein the ends of the rods 3 are flush with the ground, as was presented in an earlier passage of this description.

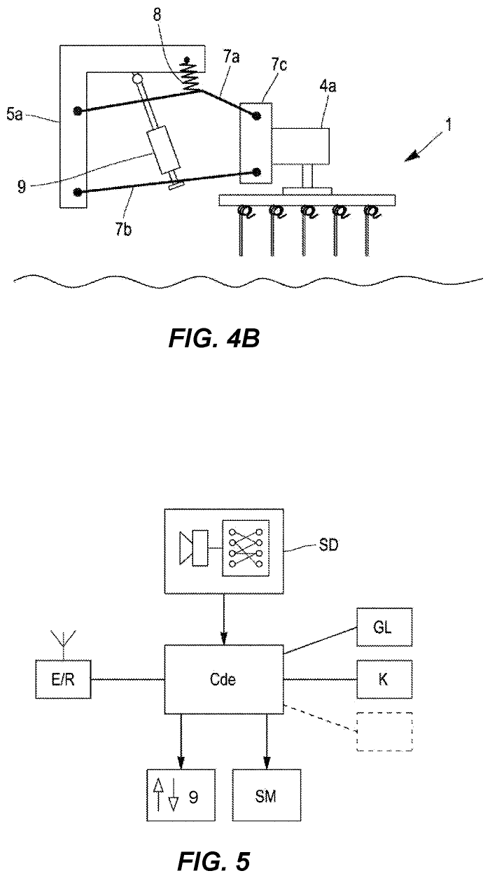

Such a device is shown in FIGS. 3, 4A and 4B. The articulated mechanism is here formed of two superimposed forks 7a, 7b. The two arms of each fork 7a, 7b are held onto the load-bearing structure 5a of the chassis 5 by means of pivot links. Similarly, the end of each fork 7a, 7b is held in pivot connection to a tool support 7c, on which the electric motor 4a of the tool 1 is attached. A retaining member, here a spring 8, connecting the load-bearing structure 5a to the upper fork, makes it possible to suspend the tool 1, that is to say by suitably choosing the stiffness of the spring according to the weight of the tool 1, to prevent it from touching the ground or to limit the pressure exerted by the ground on the rods 3. Such a mechanism allows the tool to move freely in a direction perpendicular to the ground, and to absorb the variations in the elevation of the ground when the device D is in motion.

In some embodiments, the retaining member may be adjustable such that, depending on the requirements, the distance separating the rods 3 from the ground and/or the pressure exerted by the ground on the rods 3 may be adjusted. More particularly, if the retaining member is formed of a spring 8, the spring 8 can be adjusted to modulate the return force that it exerts on the tool 1. This adjustment may, in particular, involve a mobile and/or adjustable attachment point. This adjustment aspect is not limited to only this adjustment means, and the person skilled in the art on the basis of their general knowledge could consider any other solution.

Also provided on the device D shown in FIGS. 4A and 4B is a lifting mechanism 9 of the tool 1, this mechanism 9 being associated with the articulated mechanism. The lifting mechanism 9 makes it possible to selectively place the tool 1 in a working position wherein the free ends of the rods 3 are flush with the lawn (FIG. 4A) and to place the tool in a raised position wherein the free ends of the rods 3 are distant from the lawn (FIG. 4B).

This lifting mechanism 9 therefore makes it possible to move the device D without the risk of the tool 1 colliding with the ground, for example, to lead the device over the field to be treated, at high speed. It also makes it possible to activate the treatment only on the areas of the field that require treatment, areas thus comprising a relatively large density of weeds.

The lifting mechanism 9 of the embodiment shown in FIGS. 4A and 4B consists of a controllable cylinder, arranged between the load-bearing structure 5a and the lower fork 7b of the articulated mechanism. By controlling the retraction of the cylinder, the lower fork 7b is raised, and the tool 1 is raised to position it in the raised position. Conversely, by controlling the elongation of the cylinder, the lower fork is lowered until the ends of the rods 3 are flush with the ground. It should be noted that this movement is facilitated by the presence of the retaining member 8, which makes it possible to suspend the tool 1, even when the tool is heavy.

A different lifting mechanism 9 than the one shown in FIGS. 4A and 4B may be employed in further embodiments of the present disclosure. The lifting mechanism 9 may, in particular, be a winder-cable-pulley system, which would allow the tool to be raised in an entirely similar manner by controlling the winding of a cable to which it would be attached.

### Autonomous Mechanical Maintenance Device for a Lawn

In a particularly advantageous embodiment of the invention, the mechanical maintenance device D is configured to be autonomous. The device D is therefore provided with a set of electrical and electronic elements shown in FIG. 5.

The device D is thus equipped with an electric drive system SM, as previously mentioned. This system may be formed by a motor or a plurality of motors associated with at least some of the wheels in order to enable movement along various paths, by suitably controlling such motor(s). The drive system SM also comprises an energy source, typically rechargeable batteries, connected to the motor by electrical circuits for managing the battery and power.

To allow its autonomous operation, the device D comprises an electronic box containing a control unit Cde. This unit may take the form of a board or a plurality of electronic boards comprising, in a manner known per se, at least one processor or microcontrollers enabling the execution of computer programs saved in a memory. This memory can also be used to record all the data provided by the sensors whose device D has been equipped. To allow the recording of that data and the autonomous operation of the device, the control unit Cde is electrically connected to the various electronic or electrical elements carried by the device, sensors or actuators, and, in particular, to the electric drive system SM. The electronic box containing the control unit Cde can be electrically powered by the batteries of the drive system SM or comprise its own source of electrical energy.

The device D has also been equipped with a geolocation sensor GL, for example, comprising a GPS or more generally INSS sensor. The geolocation sensor GL can also comprise an inertial unit. The control unit Cde can in this way obtain the position, the attitude and the speed of the device D, which makes it possible, in particular, to control the movement of this device along a predetermined path.

The control unit Cde can be connected to remote computing and/or storage means or to other types of electronic devices via an E/R communication interface. This interface can implement any suitable protocols. It will thus be able to connect the control unit Cde by a wireless link such as 4G, 5G, Wi-Fi, NFC BLUETOOTH®, etc. It will thus be possible to prepare, using the remote computing and/or storage means, a path that the device for mechanical maintenance of a lawn will have to follow to treat a field. This path can be transmitted to the control unit Cde via the E/R communication interface, which can then pilot the device D along this path in order to autonomously treat the lawn to be maintained.

It will naturally be possible to provide the mechanical maintenance device with any other sensor, for example, obstacle detection sensors K to stop any movement if a body is detected in the immediate environment of the device D. This may be an ultrasound proximity sensor or even a LIDAR device.

The control unit Cde is also connected to the other described elements of the device D. Thus, the control unit Cde is connected to the electric motor 4a of the tool 1, in order to control the turning on and off of the rotation of the plate 2 and of the claws 3. The control unit can also regulate the rotational speed, for example, to adjust it to the speed of advance of the device D or to the nature of the soil and/or weeds.

Advantageously, the control unit Cde is also connected to the lifting mechanism 9 of the tool 1 to selectively place this tool in the working position or in the raised position. This makes it possible, in particular, to move the device D on sections of travel with the tool 1 in the raised position, when it is not necessary or desirable to treat the ground. These may be sections of the path making it possible to bring the device D from its storage site to the ground to be treated.

It is thus possible, during the preparation of the path, to indicate the presence of the areas of the field that require treatment, and areas thus comprising a relatively large density of weeds. The control unit can then, during the movement of the device D on its path, actuate the lifting mechanism 9 of the tool 1 to place it in the working position and start the electric motor 4a only when the device D enters such areas.

In a particularly advantageous embodiment, it is not necessary to indicate in advance the presence of these areas to be treated on the terrain or along the path. In this advantageous embodiment, the control unit Cde is also connected to a system for observing the lawn and for detecting weeds SD. This system can be composed of a camera, for example, attached to the chassis and arranged at the front of the device D (relative to the direction of movement of this device). The camera is oriented so as to form successive images of the lawn. These images are provided to a detection module, for example, a neural network or any other architecture that can be configured by learning to recognize the presence of weeds in an image of the lawn. This computing architecture can be executed on the control unit Cde or on an independent unit that is nonetheless connected to the control unit Cde. The system for observing the lawn and for detecting weeds SD is therefore able to provide a signal to the control unit Cde when the device D, during its movement along the planned path, enters or exits an area of field to be treated. The control unit Cde can then control the tool 1, as described above, to place it in the working position and activate its rotation.

It can naturally be provided that the detection system SD can also indicate the nature of the recognized weeds, or at least indicate a category of weeds, in order to adjust the treatment implemented by the tool 1. This may, for example, involve adjusting the rotational speed of the plate 2, the speed of movement of the device D in the area, or even adjusting the pressure exerted by the rods 3 on the ground, if the device D is provided with a retaining member 8 making it possible to adjust this pressure.

Naturally, the present disclosure is not limited to the embodiments described, and it is possible to add alternative embodiments without departing from the scope of the invention as defined by the claims.

The device may, in particular, implement other functions than those described above. It is possible, in particular, to equip it with means for collecting and/or grinding the waste of plants that have been formed during the mechanical treatment of the ground or readings of the ground due to scarification.

Provision may also be made for a device to be equipped with a plurality of tools 1, for example, arranged in one or more rows perpendicular to the direction of advance of the device D. It is possible to treat a larger width of the field during a single pass. Each tool can then be controlled individually, for example, to place it in the working position or in the raised position, when the detection system SD identifies the presence of an area to be treated that matches one or another of the tools.

1. A device for mechanical maintenance of a lawn and limiting growth of weeds, the device including at least one tool comprising:
a plate defining a main plane and carrying a plurality of rods, the rods having sections with rounded shapes, the rods extending in a direction perpendicular to the main plane, free ends of the rods configured to be flush with the lawn, and
a drive mechanism associated with the plate and configured to rotate the assembly formed by the plate and the rods along an axis of rotation perpendicular to the main plane.

2. The device of claim 1, wherein the plate is disc-shaped and the axis of rotation intersects the plate at the center of the disc.

3. The device of claim 1, wherein the drive mechanism comprises a motor and a shaft defining the axis of rotation, the shaft of the motor being rigidly connected to the plate.

4. The device of claim 1, wherein the rods are curry-comb claws.

5. The device of claim 1, wherein the rods are retained on the plate along at least one circle whose center is in line with the axis of rotation of the tool.

6. The device of claim 1, further comprising a chassis, a plurality of wheels, the tool being held on the chassis by at least one articulated mechanism, the articulated mechanism enabling free movement of the tool in a direction perpendicular to the lawn to absorb variations in elevation of the lawn when the device is in motion and the tool is resting on the lawn.

7. The device of claim 6, wherein the articulated mechanism is connected to a load-bearing structure of the chassis, the tool being suspended from the load-bearing structure by a retaining member to control a force exerted by the ground on the rods of the tool.

8. The device of claim 7, wherein the retaining member is configured to allow adjustment of the force exerted by the ground on the rods.

9. The device of claim 6, wherein the articulated mechanism is associated with a mechanism for lifting the tool, the lifting mechanism configured to selectively place the tool in a working position wherein the free ends of the rods are flush with the lawn and to place the tool in a raised position wherein the free ends of the rods are far away from the lawn.

10. The device of claim 6, further comprising an electric drive system coupled to at least one of the wheels.

11. The device of claim 10, further comprising a control unit connected to a geolocation sensor and to the electric drive system, and wherein the device can operate autonomously.

12. The device of claim 11, wherein the articulated mechanism is associated with a mechanism for lifting the tool, the lifting mechanism configured to selectively place the tool in a working position wherein the free ends of the rods are flush with the lawn and to place the tool in a raised position wherein the free ends of the rods are far away from the lawn and wherein the control unit is connected to the lifting mechanism of the tool to selectively place the tool in the working position or in the raised position.

13. The device of claim 12, wherein the control unit is connected to a system for observing the lawn and for detecting weeds.

14. (canceled)

15. A method for treating a lawn to limit growth of weeds, the method comprising:
providing a device including a tool including:
a plate defining a main plane and carrying a plurality of rods, the rods having sections with rounded shapes, the rods extending in a direction perpendicular to the main plane, free ends of the rods configured to be flush with the lawn, and
a drive mechanism associated with the plate and configured to rotate the assembly formed by the plate and the rods along an axis of rotation perpendicular to the main plane;
positioning the tool in a working position wherein the free ends of the rods are flush with the ground; and
activating the drive mechanism and rotating the plate and the rods.

16. The method of claim 15, where the plate is disc-shaped, and wherein rotating the plate comprises rotating the plate about the center of the disc.

17. The method of claim 15, wherein the drive mechanism comprises a motor and a shaft defining the axis of rotation, the method further comprising rigidly connecting the shaft to the plate.

18. The method of claim 15, further comprising selecting the rods to be curry-comb claws.

19. The method of claim 15, wherein the rods are retained on the plate along at least one circle whose center is in line with the axis of rotation of the tool.

20. The method of claim 15, wherein the tool further comprises a chassis, a plurality of wheels, and at least one articulated mechanism holding the tool on the chassis, the method further comprising moving the tool in a direction perpendicular to the lawn with the articulated mechanism and absorbing variations in elevation of the lawn while the device is in motion and the tool is resting on the lawn.

21. The method of claim 20, wherein the articulated mechanism is connected to a load-bearing structure of the chassis, the tool being suspended from the load-bearing structure by a retaining member, the method further comprising controlling a force exerted by the ground on the rods of the tool using the retaining member.
